(19) United States
(12) Patent Application Publication
(10) Pub. No.: US 2012/0064222 A1
(43) Pub. Date: Mar. 15, 2012

(54) FOOD ADDITIVE

(76) Inventors: Deanna L. Hofing, Coatesville, IN (US); Rolf Haeussler, Oestrich-Winkel (DE)

(21) Appl. No.: 13/230,103

(22) Filed: Sep. 12, 2011

Related U.S. Application Data
(60) Provisional application No. 61/382,179, filed on Sep. 13, 2010.

(51) Int. Cl. A23L 1/237; A23L 1/28; A23L 1/22; A23L 1/304

(52) U.S. Cl. 426/615; 426/649

(57) ABSTRACT

The present invention relates to a food additive, and more particularly to a food additive that can be used to reduce the sodium content of a food additive or foodstuff. The food additive may include potassium and/or sodium citrate, sodium gluconate, potassium chloride, and optionally disodium inosinate or guanylate.

### CROSS REFERENCE TO RELATED APPLICATIONS

This application claims priority to U.S. Provisional Application Ser. No. 61/382,179, filed Sep. 13, 2010, the disclosure of which is incorporated herein by reference in its entirety.

### FIELD AND BACKGROUND OF THE INVENTION

The present invention relates to a food additive, and more particularly to a food additive that can be used to reduce the sodium content of a food additive or foodstuff.

It is well known that sodium chloride can be used in foodstuffs to enhance taste, preserve foods by suppressing antimicrobial activity, modify texture, mask off-notes, and the like. Sodium chloride at about 1,000 mg/day is a necessary nutritional compound. That being said, many people consume much larger quantities of sodium chloride because of the ingestion of processed foods. Such consumption of high amounts of sodium chloride can lead to retention of water and the attendant hypertension, a significant risk factor in heart disease, heart failure, strokes, and kidney disease. Thus, there is a need to reduce the amount of sodium chloride in food additives and foodstuff. In addition, with such high levels of consumption of sodium chloride there is a need to consume more potassium-rich foods like fruits and vegetables to balance sodium intake.

### SUMMARY OF THE INVENTION

To this end, the present invention provides a food additive that can reduce the total sodium content of a foodstuff by at least 35 percent. In general, the salt substitute comprises potassium and/or sodium citrate, sodium gluconate, potassium chloride, and optionally disodium inosinate or guanylate. In another embodiment, the present invention provides a food additive comprising potassium or sodium citrate, sodium gluconate, potassium chloride, another salt (e.g., sodium chloride) and disodium inosinate and/or guanylate.

In another embodiment of the present invention, provides a food additive comprising potassium citrate and/or sodium citrate and potassium chloride, another salt (e.g., sodium chloride), and an additive providing a source of Unami flavor.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In case of a conflict in terminology, the present specification is controlling.

The present invention provides a food additive and a salt substitute that is effective in reducing the total sodium content of a foodstuff by at least 35 percent by weight. The term “foodstuff” is intended to mean a substance which is suitable for human or animal consumption, and includes dairy products (e.g., cheese), animal foods (e.g., dog and cat food), snack foods (e.g., pretzels, chips, crackers), sauces and gravies, soups, casseroles, juices (e.g., fruits and vegetables), prepared meat and meat spreads, cereals, margarine, salad dressings, condiments (e.g., ketchup and mustard), meat and poultry. The food additive and salt substitute of the invention has been tested at the University of Wisconsin with respect to the consumer sensory perception related to texture, salty taste, bitter taste, metallic taste, overall taste intensity and overall liking with positive results. Meats tested included chicken breast, pork loin, breakfast sausage, hot dogs, roast beef and ham.

The food additive comprises 20 to 40 percent by weight potassium and/or sodium citrate; 10 to 30 percent by weight sodium gluconate; 10 to 30 percent by weight potassium chloride; 10 to 30 percent by weight of a salt other than potassium citrate, sodium gluconate, and potassium chloride; and optionally 0 to 5 percent by weight disodium inosinate or guanylate. The salt other than potassium citrate, sodium gluconate, and potassium chloride is selected from the group consisting of sodium chloride, sea salt, sodium carbonate and/or sodium bicarbonate, mixtures thereof. In one embodiment the salt is sodium chloride. The salts, particularly the potassium and/or sodium citrate, may be in buffered or unbuffered form.

The food additive may also include functional additives such as emulsifiers, preservatives, antioxidants, colorants, antimicrobials, flavorings, anti caking agents, and anti-dusting agents (e.g., vegetable oil). Preferably these additives are on the GRAS list issued by the FDA.

In another embodiment of the present invention, the food additive comprises 20 to 80 percent by weight potassium citrate and/or sodium citrate, 0.5 to 10 percent by weight of an additive providing the Unami flavor, 0 to 30 percent by weight potassium chloride, and 10 to 30 percent by weight of a salt other than potassium citrate, sodium gluconate, potassium chloride, and an additive that impacts the Unami flavor. For example, vegetables (e.g., cauliflower), vegetable extracts, mushroom, mushroom extracts, fungi, yeast extracts, and sea vegetables, and the like can be used.

In another embodiment, the present invention provides a salt substitute comprising 20 to 40 percent by weight potassium or sodium citrate, 10 to 30 percent by weight sodium gluconate, 10 to 30 percent by weight potassium chloride, and 0 to 5 percent by weight disodium inosinate and/or guanylate.

The food additive is added to the foodstuff in a forth and method known to those skilled in the art. For example, the additive can be in the form of a powder, granular blend, or a liquid, and can be applied to or mixed with the foodstuff using marination, tumbling, massaging, kneading, blending, spraying, injecting, and the like.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. A food additive comprising:
(a) 20 to 40 percent by weight potassium or sodium citrate;
(b) 10 to 30 percent by weight sodium gluconate;
(c) 10 to 30 percent by weight potassium chloride;
(d) 10 to 30 percent by weight of a salt other than potassium citrate, sodium gluconate, and potassium chloride; and
(e) 0 to 5 percent by weight disodium inosinate and/or guanylate.

2. A food additive according to claim 1, wherein the salt, other than potassium citrate, sodium gluconate, and potassium chloride, is sodium chloride.

3. A food additive according to claim 1, wherein the salt other than potassium citrate, sodium gluconate, and potassium chloride is selected from the group consisting of sodium chloride, sea salt, sodium carbonate and/or sodium bicarbonate, mixtures thereof.

4. The food additive according to claim 1, wherein the potassium or sodium citrate is buffered or unbuffered.

5. The food additive according to claim 1, further comprising 1 to 10 percent by weight of an additive providing a Unami flavor.

6. The food additive according to claim 5, wherein the additive providing the Unami flavor is selected from the group consisting of vegetables, vegetable extracts, mushroom, mushroom extracts, fungi, yeast extracts, and sea vegetables.

7. A method of reducing the sodium content of a foodstuff typically flavored using sodium chloride comprising adding a sufficient amount of a food additive comprising potassium or sodium citrate, sodium gluconate, potassium chloride, potassium or sodium chloride and disodium inosinate or guanylate to reduce the total sodium content of the foodstuff by at least 35 percent by weight.

8. A salt substitute composition comprising:
(a) 20 to 40 percent by weight potassium or sodium citrate;
(b) 0 to 5 percent by weight disodium inosinate or guanylate;
(c) 30 to 50 percent by weight potassium chloride; and
(d) 15 to 30 percent by weight of a salt other than potassium citrate, sodium gluconate, and potassium chloride.

9. The food additive according to claim 8, wherein the potassium or sodium citrate is buffered or unbuffered.

10. The food additive according to claim 8, further comprising 1 to 10 percent by weight of an additive providing the Unami flavor.

11. The food additive according to claim 10, wherein the additive providing the Unami flavor is selected from the group consisting of vegetable extracts, mushroom, mushroom extracts, fungi, yeast extracts, and sea vegetables.

12. A food additive comprising:
(a) 20 to 80 percent by weight potassium citrate and/or sodium citrate;
(b) 0.5 to 10 percent by weight of an additive providing the Unami flavor;
(c) 0 to 30 percent by weight potassium chloride; and
(d) 10 to 30 percent by weight of a salt other than potassium citrate, sodium gluconate, and potassium chloride.

13. A food additive according to claim 12, wherein the salt, other than potassium citrate, sodium gluconate, and potassium chloride, is sodium chloride.

14. A food additive according to claim 12, wherein the salt other than potassium citrate, sodium gluconate, and potassium chloride is selected from the group consisting of sodium chloride, sea salt, sodium carbonate and/or sodium bicarbonate, mixtures thereof.

15. The food additive according to claim 12, wherein the potassium or sodium citrate is buffered or unbuffered.

16. The food additive according to claim 12, wherein the additive providing the Unami flavor is selected from the group consisting of vegetables, vegetable extracts, mushroom, mushroom extracts, fungi, yeast extracts, and sea vegetables.
